(19) United States
(12) Patent Application Publication
(10) Pub. No.: US 2026/0116516 A1
(43) Pub. Date: Apr. 30, 2026

(54) INFORMATION PROCESSING APPARATUS, INFORMATION PROCESSING METHOD, AND STORAGE MEDIUM

(71) Applicant: TOYOTA JIDOSHA KABUSHIKI KAISHA, Toyota-shi (JP)

(72) Inventor: Naoki MAETANI, Hamamatsu-shi (JP)

(73) Assignee: TOYOTA JIDOSHA KABUSHIKI KAISHA, Toyota-shi (JP)

(21) Appl. No.: 19/345,104

(22) Filed: Sep. 30, 2025

(30) Foreign Application Priority Data
Oct. 31, 2024 (JP) 2024-192436

(51) Int. Cl. B63B 79/40; A01K 79/00; B63B 79/10; G01S 7/62; G01S 15/96; G05D 1/242; G05D 1/656; G05D 107/00; G05D 109/30; G05D 111/20

(52) U.S. Cl. CPC B63B 79/40; A01K 79/00; B63B 79/10; G01S 7/62; G01S 15/96; G05D 1/242; G05D 1/656; G05D 2107/27; G05D 2109/34; G05D 2111/20

(57) ABSTRACT

An information processing apparatus according to an aspect of the present disclosure includes a controller. The controller is configured to execute acquiring a search result of a fish school by a sonar provided in the ship, the search result indicating a position of the fish school with respect to the ship, setting the position of the fish school indicated by the acquired search result as a target point to activate autonomous navigation of the ship, and stopping the autonomous navigation in response to the ship reaching the position of the fish school.

### CROSS-REFERENCE TO RELATED APPLICATION

This application claims priority to Japanese Patent Application No. 2024-192436 filed on Oct. 31, 2024. The disclosure of the above-identified application, including the specification, drawings, and claims, is incorporated by reference herein in its entirety.

### BACKGROUND

### 1. Technical Field

The present disclosure relates to an information processing apparatus, an information processing method, and a storage medium.

### 2. Description of Related Art

Japanese Unexamined Patent Application Publication No. 2014-002084 (JP 2014-002084 A) proposes an underwater detection device that displays an echo image of a detected fish school in association with fish species information received from an external device.

### SUMMARY

One object of the present disclosure is to provide a technique for performing autonomous navigation by setting a position of a fish school captured by a sonar as a destination.

An information processing apparatus according to a first aspect of the present disclosure includes a controller. The controller is configured to acquire a search result of a fish school by a sonar provided in a ship, the search result indicating a position of the fish school with respect to the ship. The controller is configured to set the position of the fish school indicated by the acquired search result as a target point to activate autonomous navigation of the ship. The controller is configured to stop the autonomous navigation in response to the ship reaching the position of the fish school.

According to the present disclosure, it is possible to perform autonomous navigation by setting the position of the fish school captured by the sonar as the target point.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows an example of a scene to which the present disclosure is applied;

FIG. 2 schematically shows an example in which the movement of the fish school is detected during the autonomous navigation of the ship and the target point is reset;

FIG. 3 schematically shows an example of a case where the movement of the fish school is detected after the target point is reached and the autonomous navigation of the ship is reactivated;

FIG. 4 schematically shows an example of a hardware configuration of the server of the present disclosure; and

FIG. 5 is a flowchart showing an example of a processing procedure in a case where the control device of the present disclosure controls autonomous navigation of the ship S toward the position of the fish school.

### DETAILED DESCRIPTION OF EMBODIMENTS

For example, in a related art system disclosed in JP 2014-002084 A, the echo image of the detected fish school is displayed in association with the fish species information received from the external device. The fish species information includes position information of the fish school. With the system, it is possible to approach the target fish school after specifying the kind of fish in the fish school displayed in the image. However, in the related art system, when the user moves the ship toward the position of the fish school, the user has to continue to grasp the position of the fish school in the displayed image. For the user, it may be troublesome to steer while the image in which the position of the fish school is indicated is viewed. While the user is moving the ship toward the position of the fish school, the user cannot perform an act other than steering (fishing activity, preparation for fishing activity, and the like), so that the efficiency of the fishing activity may be reduced.

On the other hand, the information processing apparatus according to the first aspect of the present disclosure includes a controller. The controller is configured to acquire a search result of a fish school by a sonar provided in the ship, the search result indicating a position of the fish school with respect to the ship. The controller sets the position of the fish school indicated by the acquired search result as the target point to activate the autonomous navigation of the ship. The controller is configured to stop the autonomous navigation in response to the fact that the ship has reached the position of the fish school. According to the configuration, the ship can automatically follow the fish school until the ship reaches the position of the target fish school. As a result, at least a part of the user's act related to the steering can be reduced during autonomous navigation of the ship. Therefore, it is possible to expect a reduction in the user's labor. Further, since at least a part of the act related to the steering is reduced during the autonomous navigation of the ship, the user can perform the activity related to the fishery, and thus the efficiency of the fishery activity can also be expected to be improved.

As another aspect of the information processing apparatus according to the aspect, one aspect of the present disclosure may be an information processing method that realizes all or a part of the configuration elements, a program, or a machine-readable storage medium, such as a computer, which stores such a program. The storage medium that can be read by a machine, such as a computer, is a medium that stores information, such as a program, by an electrical, magnetic, optical, mechanical, or chemical action.

### 1. Application Example

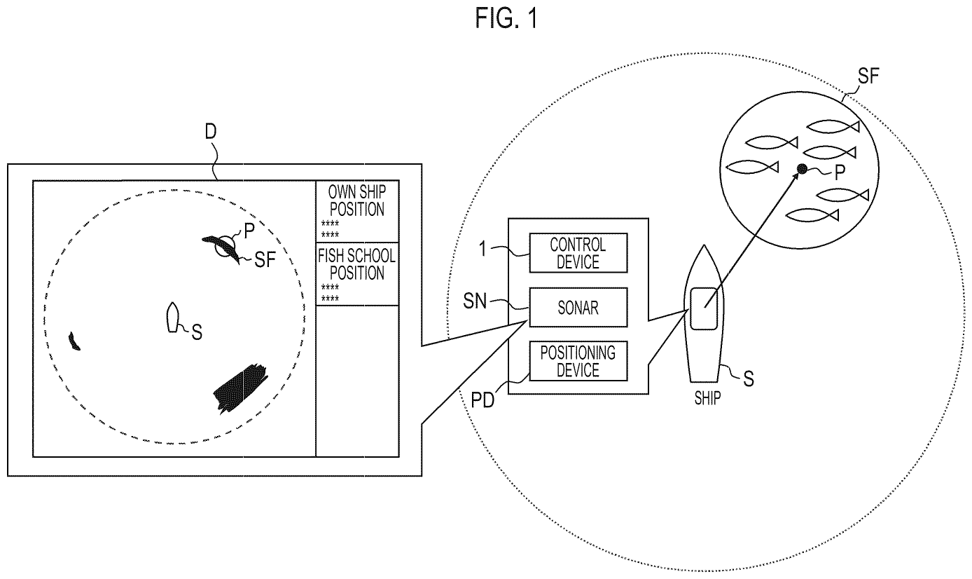

FIG. 1 schematically shows an example of a scene to which the present disclosure is applied. A control device 1 according to the present embodiment is an example of an information processing apparatus. First, the control device 1 searches for the fish school SF by using the sonar SN. The control device 1 acquires a search result indicating the position P of the searched fish school SF for the ship S. The control device 1 sets the position P indicated by the acquired search result as the target point. After the target point is set, the control device 1 activates the autonomous navigation of the ship S.

### Ship

In a case where the fish school SF can be detected and the autonomous navigation can be performed by the sonar SN, the type of the ship S (power source, size, and the like) may be appropriately selected according to the embodiment. The power source of the ship S may be selected from, for example, electricity and fuel. The size of the ship S may be selected from a large ship, a medium-sized ship, a small ship, and the like. The user may be a crew member (operator) of the ship S.

### Sonar

The sonar SN is a device that emits ultrasonic waves toward the sea and searches for the fish school SF based on reflected waves of the ultrasonic waves. The search result by the sonar SN may be displayed on a screen, such as a display. As long as the vicinity of the own ship can be searched, the type of the sonar SN is not particularly limited, and may be appropriately selected according to the embodiment. In an example, the sonar SN may include a fish school finder, a scanning sonar, a searchlight sonar, or the like.

As shown in FIG. 1, for example, the display image D of the search result by the sonar SN may display the own ship (ship S), the azimuth, a portion indicating a reaction to the ultrasonic wave (including a reaction of the fish school), the position information of the ship S, or the distance and the azimuth of the position P of the fish school SF with respect to the ship S. The position information of the ship S may be acquired from the positioning device PD. The distance of the position P may be displayed as a straight-line distance, or a horizontal distance and a vertical distance with respect to the traveling direction of the ship S may be displayed, respectively. The orientation of the position P may be displayed in an absolute orientation or may be displayed in a relative orientation from the traveling direction of the ship S. The display image D of the search result by the sonar SN is not limited to such an example, and may be appropriately changed according to the embodiment.

The positioning device PD is configured to measure the position of the ship S. As long as the position is measurable, the type of the positioning device PD is not particularly limited and may be appropriately selected according to the embodiment. Typically, the positioning device PD may be a satellite positioning device, such as a global navigation satellite system (GNSS) receiver. The GNSS includes, for example, a global positioning system (GPS), a quasi-zenith satellite system (QZSS), GLONASS, and Galileo.

### Determination of Whether There is Fish School

When the display image D of the search result by the sonar SN includes a portion indicating a reaction to the ultrasonic wave, the control device 1 may appropriately determine whether the portion is the fish school SF. In one example, the control device 1 may identify the portion by performing image analysis on the display image D of the search result. The identification method by image analysis may be appropriately decided according to the embodiment. In one example, the control device 1 may identify the part from the feature (appearance or the like) of the part.

The method of image analysis is not particularly limited and may be appropriately selected according to the embodiment. In an example, the control device 1 may analyze the display image D by a general image analysis method, such as edge detection or pattern matching. In another example, the control device 1 may analyze the display image D by using a trained machine learning model that has acquired the ability to analyze the image. The machine learning model is configured to include one or more calculation parameters that are adjustable by machine learning. The one or more calculation parameters are used for the calculation of the desired inference (image analysis or the like). The machine learning model may be constituted by, for example, a neural network, a support vector machine, or another functional expression (operation model). The method of machine learning may be appropriately selected according to the machine learning model to be adopted (for example, an error back propagation method). Training the machine learning model is to adjust (optimize) the value of the calculation parameter using the training sample. The machine learning model may be appropriately trained to derive the true value of the corresponding analysis result when the image of the training sample is given. A large-scale model, such as a large-scale visual language model, may be used for the trained machine learning model.

In a case where the portion showing the reaction to the ultrasonic wave is determined to be the fish school SF, the control device 1 may output the determination result. In one example, the output of the determination result may include displaying information indicating the determination result on the display image D. The information indicating the determination result may be displayed by displaying a text in the portion or in the vicinity of the portion, changing a color of the portion, or the like. In a case where the determination is made that the portion is not the fish school SF, the control device 1 may omit output of the determination result.

### Designation of Position of Fish School

The position P of the fish school SF may be automatically specified by the control device 1 or may be manually specified by the user. In a case where the position P is automatically specified by the control device 1, the control device 1 may optionally specify a point inside a portion determined as the fish school SF on the display image D as the position P. The point inside the area may be, for example, the center of gravity of a portion indicating the presence of the fish school SF. In the display image D, in a case where a determination is made that a plurality of parts are the fish schools SF, the fish schools SF to be set as the target point may be optionally decided. In one example, the fish school SF to be set as the target point may be decided depending on the size (area) of the portion indicating the presence of the fish school SF. In another example, the fish school SF to be set as the target point may be decided depending on the distance from the ship S. In a case where the position P is manually specified by the user, the output device, such as a display, may be configured to indicate any position on the display image D. In this case, the position P may be a point indicated by the user's input operation.

### Autonomous Navigation of Ship

The method of autonomous navigation of the ship S may include any method of executing autonomous navigation toward the target point. A known method may be adopted as the method of autonomous navigation of the ship S. In an example, the autonomous navigation method may be a method of controlling the vehicle in any way toward a point (target point) indicated by the position information of the specified position P. In an example, the control method may include controlling a distance and a bearing of the ship S according to the navigation route acquired by referring to map information 83. The control device 1 may appropriately search for the route from the current position of the ship S to the target point in the map information 83.

The map information 83 may be incorporated in a storage unit 12 in advance or may be provided from an external computer via a network. The external computer is any computer other than the control device 1. For example, the external computer may be a server device or a user terminal. The map information 83 may be configured in any data format in which the search for the route is possible. A known data format may be adopted as the data format of the map information 83. In addition, the search for the route may not always be executed on the control device 1, and may be executed on any other computer. The control device 1 may acquire the route by receiving the calculation result from the other computer.

In another example, the control method may include converting the positional information of the target point into a distance and an azimuth with respect to the position of the own ship, and autonomously navigating by the distance in a direction of the obtained azimuth. The control device 1 may stop the autonomous navigation after the ship S has moved by the distance.

The control device 1 may execute various controls related to navigation during autonomous navigation of the ship S along the route. In an example, the navigation control may include acquiring a current position, adjusting a moving speed, controlling an orientation of the hull, detecting and avoiding an obstacle, and the like. In a case where the obstacle is detected, the ship S may further include any sensor. In an example, the ship S may further include a detection sensor. For example, the detection sensor may include an imaging device. The imaging device may be appropriately disposed in a place where the surrounding object is observable during navigation of the ship S. The type of the imaging device is not particularly limited and may be appropriately selected according to the embodiment. The imaging device may include any sensor that acquires data in an image or image representation, such as an RGB camera, a depth sensor, an infrared sensor, a radar, or a light detection and ranging (LiDAR).

The arrival of the ship S at the target point may be detected by any method. In an example, the arrival at the target point may be detected by a method using the current position of the ship S. In this case, the control device 1 may continuously acquire the current position measured by the positioning device PD. The control device 1 may detect the arrival at the target point depending on the distance between the current position of the ship S and the target point. For example, the control device 1 may detect the arrival at the target point at the timing when the current position and the target point are closer than a predetermined distance. The method of detecting the arrival at the destination is not limited to such an example, and may be appropriately changed according to the embodiment.

The control device 1 may monitor the movement of the ship S by continuously acquiring the current position measured by the positioning device PD. In the monitoring of the movement, the control device 1 may determine whether the acquired current position satisfies a predetermined condition. When the acquired current position satisfies a predetermined condition, the control device 1 may execute a process of stopping autonomous navigation. On the other hand, when the current position does not satisfy the predetermined condition, the control device 1 may omit the execution of the process of stopping the autonomous navigation. The predetermined condition may typically be that the current position of the ship S is away from the route by a certain time.

### Fish School Search During Autonomous Navigation

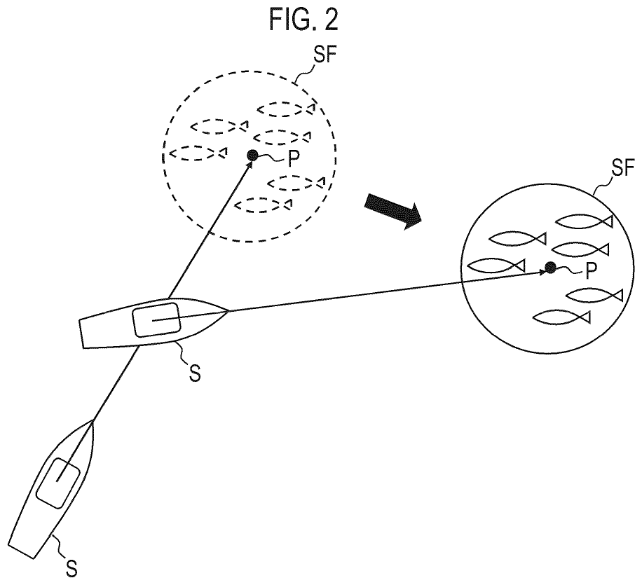

FIG. 2 schematically shows an example in which the movement of the fish school SF is detected during the autonomous navigation of the ship S and the target point is set again. The position P of the fish school SF may be moved while the ship S is moving toward the position P. Therefore, while the autonomous navigation is activated toward the position P of the fish school SF set as the target point, the control device 1 may acquire the search result by the sonar SN again. When the position P (new position P) of the fish school SF indicated by the search result acquired again is away from the set target point (original position P), the control device 1 may change the target point to the new position P. Whether the new position P is away from the original position P may be appropriately determined. In one example, the new position P may be determined to be away from the original position P according to whether a difference in distance between the new position P and the original position P exceeds a predetermined threshold value. In a case where the difference in the distances is equal to a predetermined threshold value, the determination may be made to either one. The predetermined threshold value may be appropriately set. When determination is made that the new position P is away from the original position P, the control device 1 may decide the route again in accordance with the position P of the new target point and perform autonomous navigation along the route.

The frequency of the re-search of the fish school SF by the sonar SN while the autonomous navigation is being activated may be appropriately decided according to the embodiment. In an example, the fish school SF may be searched again by the sonar SN at a predetermined time interval. The predetermined time interval may be appropriately set. For example, the predetermined time interval may be set to a fixed value. In addition, the predetermined time interval may be dynamically set in accordance with the distance from the ship S to the position P of the target point. In this case, as the distance from the ship S to the position P is longer, the predetermined time interval may be set to be shorter, and as the distance from the ship S to the position P is shorter, the predetermined time interval may be set to be longer. The correspondence between the distance from the ship S to the position P and the predetermined time interval may be opposite to the correspondence.

As described above, even when the ship S is heading to the position P by autonomous navigation, the control device 1 can capture the fish school SF that has moved while the ship S is heading to the position P by performing the search of the fish school SF by the sonar SN again. As a result, the route for autonomous navigation is modified, and it is expected that the position P of the fish school SF can be efficiently aimed at.

### Fish School Search After Arrival at Target Point

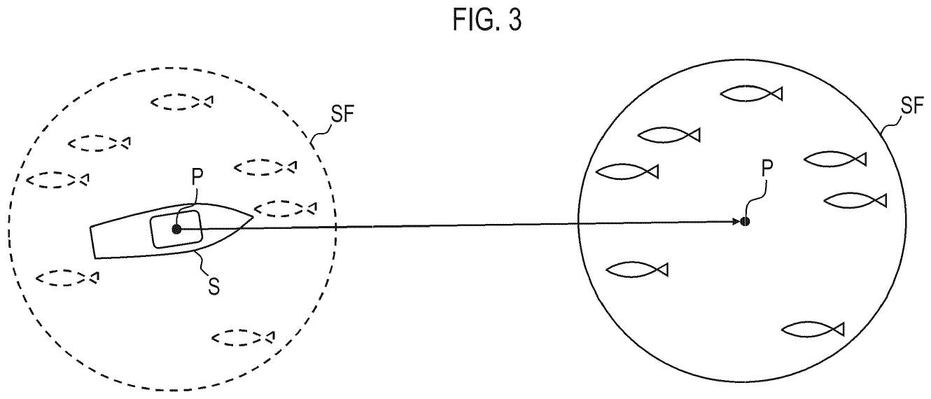

FIG. 3 schematically shows an example in which the movement of the fish school SF is detected after the target point is reached and the autonomous navigation of the ship S is reactivated. When the ship S reaches the position P of the fish school SF, the control device 1 may stop the activation of the autonomous navigation of the ship S. After the autonomous navigation of the ship S is stopped, the control device 1 may acquire the search result by the sonar SN again. When the new position P of the fish school SF indicated by the search result acquired again is away from the stop point of the ship S, the control device 1 may reactivate the autonomous navigation of the ship S by using the new position P of the fish school SF indicated by the search result acquired again as the target point. The determination as to whether the new position P is away from the stop point of the ship S may be appropriately made. In one example, the new position P may be determined to be away from the stop point of the ship S according to whether the difference between the new position P and the stop point of the ship S is greater than a predetermined threshold value. In a case where the difference in the distances is equal to a predetermined threshold value, the determination may be made to either one. The predetermined threshold value may be appropriately set.

When the ship S reaches the position P and stops, the position P of the fish school SF may be moved from the point where the fish school SF was last searched by the sonar SN to the position P where the ship S reaches. Therefore, even after the ship S reaches the position P that is the target point, the control device 1 can assist the ship S in reaching the position P of the fish school SF more reliably by performing the search of the fish school SF by the sonar SN again.

The determination as to whether the portion that shows the reaction to the ultrasonic wave is the fish school SF, the determination as to whether the position P of the fish school SF is moved, and the determination as to whether the ship S arrives at the position P of the fish school SF may not always be executed by the control device 1, as in the search for the route described above. In an example, the determination may be executed by an external computer. The external computer may be a server device, a user terminal, or the like. For example, the control device 1 may request the external computer to transmit the determination result by transmitting the display image D of the fish school SF to the external computer. The determination method may be the same as that of the control device 1. The external computer may return the determination result to the control device 1. The control device 1 may acquire the determination result by receiving the determination result.

### 2. Configuration Example

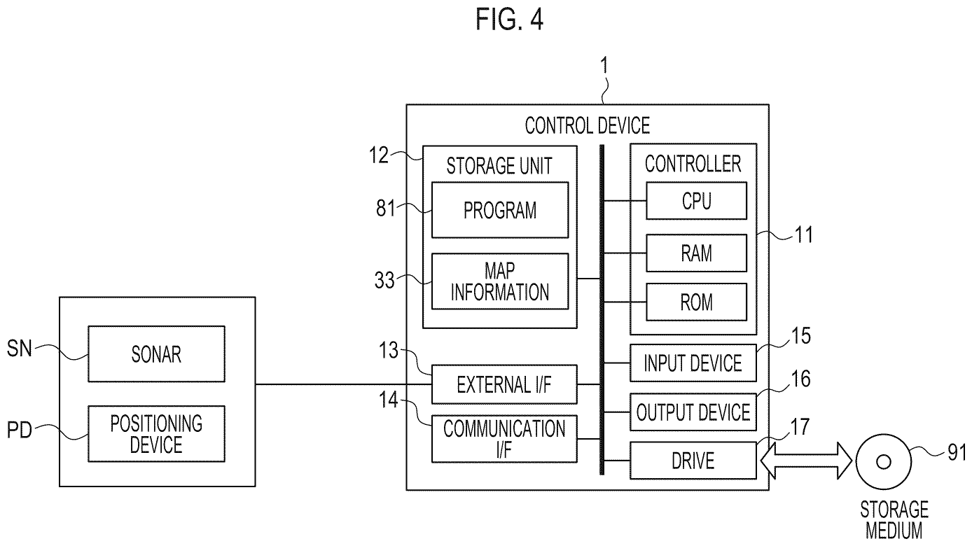

FIG. 4 schematically shows an example of a hardware configuration of the control device 1 of the present disclosure. As shown in FIG. 4, the control device 1 according to the present embodiment is a computer in which a controller 11, the storage unit 12, an external interface 13, a communication interface 14, an input device 15, an output device 16, and a drive 17 are electrically connected. The controller 11 includes a central processing unit (CPU), a random access memory (RAM), a read only memory (ROM), and the like, and is configured to execute any information processing. The storage unit 12 may be configured by, for example, a hard disk drive or a solid state drive. In the present embodiment, the storage unit 12 stores a program 81. The program 81 is a program for causing the information processing to be executed on the information processing apparatus according to the present embodiment. The program 81 includes a series of commands for the information processing.

The external interface 13 may be, for example, a universal serial bus (USB) port, a dedicated port, or a wireless communication port, and is configured to be connected to the external device by wire or wirelessly. In the present embodiment, the control device 1 may be connected to the sonar SN and the positioning device PD via the external interface 13.

The communication interface 14 is configured to perform data communication by wire or wireless through a network. The communication interface 14 may be configured by, for example, a wired local area network (LAN) module, or a wireless LAN module. In the present embodiment, the control device 1 may execute data communication with another computer (for example, an external server or a user terminal) via the communication interface 14. The input device 15 is a device that performs input of, for example, a mouse, a keyboard, a button, a joystick, or an operator. The output device 16 is a device that outputs, for example, a display or a speaker. The input device 15 and the output device 16 may be integrally configured by, for example, a touch panel display.

The drive 17 is a device that reads various pieces of information, such as a program, stored in a storage medium 91. The program 81 may be stored in the storage medium 91 instead of the storage unit 12 or together with the storage unit 12. The storage medium 91 is configured to store the information by an electrical, magnetic, optical, mechanical, or chemical action such that a machine, such as a computer, can read various pieces of information (stored programs, and the like). The control device 1 may acquire the program 81 from the storage medium 91. The storage medium 91 may be a disk-type storage medium, such as a CD or a DVD, or may be a non-disk-type storage medium, such as a semiconductor memory (for example, a flash memory). The type of the drive 17 may be appropriately selected according to the type of the storage medium 91.

It should be noted that, with respect to the specific hardware configuration of the control device 1, the omission, substitution, and addition of the components can be appropriately made according to the embodiment. For example, the controller 11 may include a plurality of hardware processors. The hardware processor may be configured by a microprocessor, a field-programmable gate array (FPGA), a digital signal processor (DSP), a graphics processing unit (GPU), an application specific integrated circuit (ASIC), or the like.

### 3. Operation Example

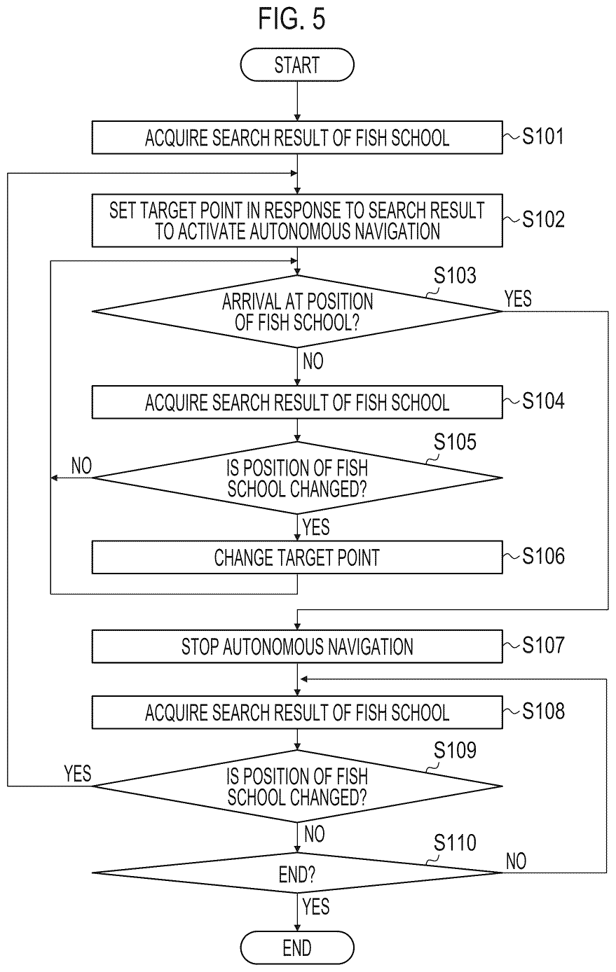

FIG. 5 is a flowchart showing an example of a processing procedure in a case where the control device 1 of the present disclosure controls autonomous navigation of the ship S toward the position P of the fish school SF. The following processing procedure is an example of a control method (information processing method) executed by a computer (control device 1).

### From S101 to S102

In S101, the controller 11 acquires the search result of the fish school SF from the sonar SN. In S102, when the acquired search result includes the fish school SF, the controller 11 sets the position P of the fish school SF as the target point. The controller 11 may activate the autonomous navigation of the ship S with the position P as a target point. The route for autonomous navigation may be appropriately decided. In an example, the route may be searched from the map information 83. When the autonomous navigation of the ship S is activated, the controller 11 proceeds to the next S103.

### From S103 to S106

In S103, the controller 11 determines whether the ship S autonomously navigating has arrived at the position P (target point). The determination method of whether the arrival is made may be appropriately decided. When the controller 11 determines that the ship S has arrived at the position P, the controller 11 proceeds with the process to S107. On the other hand, in a case where the controller 11 determines that the ship S does not arrive at the position P, the controller 11 progresses the process to S104, and the search result of the fish school SF may be acquired again from the sonar SN. In response to the fact that the search result of the fish school SF is acquired, the controller 11 may determine whether the position P is changed in S105. A determination method as to whether the position P has changed may be appropriately decided. When the controller 11 determines that the position P is not changed, the controller 11 may return the process to S103 and determine whether the ship S has arrived at the position P. On the other hand, when determination is made that the position P is changed, the controller 11 may proceed to the process of S106, and set the new position P after the change as the target point again. As a result, the controller 11 may change (correct) the target point. In addition, the controller 11 may modify the route of the autonomous navigation of the ship S such that the ship S navigates to the new position P as a target point. In one example, the modification of the route may include searching for the route again from the map information 83. After the target point is changed, the controller 11 may return the process to S103 and execute the determination as to whether the ship S has arrived at the position P again. The execution of S104 to S106 may be executed at any timing after the determination is made in S103 that the ship S has not arrived at the position P of the fish school SF.

### From S107 to S110

In S107, the controller 11 stops the autonomous navigation of the ship S. Thereafter, in S108, the controller 11 may acquire the search result of the fish school SF from the sonar SN again. In response to the fact that the search result of the fish school SF is acquired, the controller 11 may determine whether the position P is changed in S109. When determination is made that the position P is changed, the controller 11 returns the process to S102, and may reactivate the autonomous navigation of the ship S with the new position P of the fish school SF as the target point. When the controller 11 determines that the position P is not changed, the controller 11 progresses the process to S110 to determine whether to end the search for the fish school. Whether to end the search for the fish school SF may be determined based on any criterion. For example, until any end instruction is given, the controller 11 may determine that the search for the fish school SF is not ended. On the other hand, when the end instruction is given, the controller 11 may determine that the search for the fish school SF is to be ended. When the controller 11 determines that the search is not to be terminated, the controller 11 may return the process to S108 to acquire the search result of the group SF again. When the controller 11 determines that the exploration is to be terminated, the controller 11 ends the processing procedure according to the present embodiment.

### Feature

In the present embodiment, the control device 1 specifies the position P of the fish school SF by the sonar SN, and then activates the autonomous navigation of the ship S with the position P as the target point. As a result, it is possible to reduce the effort of the user to visually recognize the image in which the result of the fish school search is output. In addition, even while the movement by autonomous navigation is performed toward the position P, the search result by the sonar SN is acquired, and determination is made whether the new position P included in the search result is away from the original position P. When the new position P is away from the original position P, the target point of the autonomous navigation is set again to the new position P. As a result, in a case where the fish school SF moves during autonomous navigation, the route of the autonomous navigation can be modified, and it is expected that the position P of the fish school SF can be efficiently aimed at. Further, even when the autonomous navigation is stopped upon arrival at the position P, the search result by the sonar SN is acquired again, and determination is made as to whether the new position P included in the search result is away from the original position P (stop point). When the new position P is away from the stop point, the autonomous navigation of the ship S is reactivated with the new position P as the target point. As a result, the control device 1 can assist the ship S in reaching the position P of the fish school SF more reliably.

### 4. Modification

In S102, the target point for the autonomous navigation of the ship S may be a point other than the position P. In an example, the target point may be the predicted position of the fish school SF after a predetermined time has elapsed. The predetermined time may be any time. In an example, the predetermined time may be a needed time until the target point is reached by autonomous navigation.

The method of predicting the position of the fish school SF may be appropriately selected according to the embodiment. Any information may be used for the prediction. The information used for the prediction may include, for example, attribute information of the fish school SF or environmental information. The attribute information may include a kind of fish, a swimming speed, a swimming pattern, and the like, which configure the fish school SF. The environmental information may include water temperature, sea current speed, and the like.

The control device 1 may predict the position of the fish school SF by any method from the information. A prediction model may be used for the prediction calculation. In an example, the prediction model may be configured by at least any one of a rule-based model and a trained machine learning model (trained model).

The rule-based model is configured to derive the inference result (predicted position of the fish school SF) from the given input in accordance with the rule. The rule may be appropriately set. In an example, the rule for deciding the predicted position may use the information on the fish species and the swimming speed among the attribute information of the fish school SF. For example, the rule may include calculating a range that can be reached at the swimming speed of the fish species after a predetermined time has elapsed from the information. In this case, the predicted position of the fish school SF may be selected from any point within the range.

The machine learning model is configured to include one or more calculation parameters that are adjustable by machine learning. One or more calculation parameters are used for the calculation of the desired inference (prediction of the position of the fish school SF). The machine learning model may be constituted by, for example, a neural network, a support vector machine, or another functional expression (operation model). The method of machine learning may be appropriately selected according to the machine learning model to be adopted (for example, an error back propagation method). In an example, the machine learning model that predicts the position of the fish school SF may be a trained machine learning model that has acquired the ability to predict the position.

Further, the processing procedure of FIG. 5 is merely an example, and each step may be changed as much as possible. In the processing procedure of FIG. 5, the steps can be appropriately omitted, replaced, and added according to the embodiment. For example, in a case where the fish school search during autonomous navigation is omitted, the processing from S104 to S106 may be omitted. In addition, for example, in a case where the fish school search after arrival at the target point is omitted, the processing from S108 to S109 may be omitted.

Although the embodiments of the present disclosure have been described in detail above, the description provided above is merely illustrative of the present disclosure in all respects. It is needless to say that various modifications or variations can be made without departing from the scope of the present disclosure. The processing and the methods described in the present disclosure can be freely combined and implemented as long as there is no technical contradiction.

In the embodiment, the control device 1 is an example of an information processing apparatus. However, the form of the information processing apparatus is not limited to such an example, and may be appropriately changed according to the embodiment. In another example, the terminal, such as a personal computer (PC), a tablet terminal, or a mobile terminal, may be configured to execute the arithmetic processing of the control device 1. As a result, the terminal may be an example of the information processing apparatus.

What is claimed is:

1. An information processing apparatus comprising a controller, wherein the controller is configured to execute:
acquiring a search result of a fish school by a sonar provided in a ship, the search result indicating a position of the fish school with respect to the ship;
setting the position of the fish school indicated by the acquired search result as a target point to activate autonomous navigation of the ship; and
stopping the autonomous navigation in response to the ship reaching the position of the fish school.

2. The information processing apparatus according to claim 1, wherein the controller is further configured to execute:
acquiring the search result by the sonar again while the autonomous navigation is activated toward the position of the fish school; and
change, when the position of the fish school indicated by the search result acquired again is away from the set target point, the target point to the position of the fish school indicated by the search result acquired again.

3. The information processing apparatus according to claim 1, wherein the controller is further configured to execute:
acquiring the search result by the sonar again after the autonomous navigation is stopped; and
reactivating, when the position of the fish school indicated by the search result acquired again is away from a stop point, the autonomous navigation of the ship with the position of the fish school indicated by the search result acquired again as the target point.

4. An information processing method executed by a computer, the method comprising:
acquiring a search result of a fish school by a sonar provided in a ship, the search result indicating a position of the fish school with respect to the ship;
setting the position of the fish school indicated by the acquired search result as a target point to activate autonomous navigation of the ship; and
stopping the autonomous navigation in response to the ship reaching the position of the fish school.

5. A non-transitory storage medium storing a program that causes a computer to execute an information processing method comprising:
acquiring a search result of a fish school by a sonar provided in a ship, the search result indicating a position of the fish school with respect to the ship;
setting the position of the fish school indicated by the acquired search result as a target point to activate autonomous navigation of the ship; and
stopping the autonomous navigation in response to the ship reaching the position of the fish school.
